(19) United States
(12) Patent Application Publication
(10) Pub. No.: US 2012/0088178 A1
(43) Pub. Date: Apr. 12, 2012

(54) FUEL CELL AND MANUFACTURING METHOD THEREOF

(75) Inventors: Kyong Bok MIN, Busan (KR); Jae Hyuk JANG, Seoul (KR); Jong Ho CHUNG, Gyunggi-do (KR); Sung Han KIM, Gyunggi-do (KR)

(73) Assignee: SAMSUNG ELECTRO-MECHANICS CO., LTD., Gyunggi-do (KR)

(21) Appl. No.: 13/180,919

(22) Filed: Jul. 12, 2011

(30) Foreign Application Priority Data
Oct. 11, 2010 (KR) 10-2010-0098779

(51) Int. Cl. H01M 8/24; H01M 8/10; H01M 8/00

(52) U.S. Cl. 429/465; 429/535

(57) ABSTRACT

There are provided a fuel cell and a manufacturing method thereof. The manufacturing method of a fuel cell includes: providing a support for a fuel cell; and forming an interconnecting member layer including metal-glass and interconnecting unit cells on the support. According to the present invention, since an interconnecting member having high durability, chemical resistance properties and improved electrical conductivity is provided, a fuel cell having improved electrical characteristics and an improved durability may be provided.

### CROSS-REFERENCE TO RELATED APPLICATIONS

This application claims the priority of Korean Patent Application No. 10-2010-0098779 filed, on Oct. 11, 2010, in the Korean Intellectual Property Office, the disclosure of which is incorporated herein by reference.

### BACKGROUND OF THE INVENTION

1. Field of the Invention

The present invention relates to a fuel cell and a manufacturing method thereof, and more particularly, to a fuel cell having excellent electrical conductivity and high durability and a manufacturing method thereof.

2. Description of the Related Art

In general, there are various kinds of fuel cells such as a Polymer Electrolyte Membrane Fuel Cell (PEMFC), a Direct Methanol Fuel Cell (DMFC), a Molten Carbonate Fuel Cell (MCFC), a Solid Oxide Fuel Cell (SOFC), a Phosphoric-Acid Fuel Cell (PACF), an Alkali Fuel Cell (AFC) and the like.

Among others, the solid oxide fuel cell (SOFC) uses a solid ceramic as an electrolyte so that the production of electricity occurs through an electrochemical reaction between fuel and oxygen at a high operating temperature in the range of 600° C. to 1000° C., thereby having highest level of power generation efficiency. Also, the SOFC is able to use high-temperature exhaust gas, such that it may be used in co-generation.

In the case of the SOFC, a unit cell configuring the fuel cell and a stack of the fuel cell must have durability under extreme environmental conditions, and long-term stability.

As the SOFC, various shapes of fuel cells have been studied, such as cylindrical, flat, disk shaped and the like.

Among the SOFCs having various shapes, the cylindrical SOFC has a small burden in terms of durability, starting time, resistance to thermal shock, and gas sealing. Also, the cylindrical SOFC is appropriate for making a large cell since it has excellent mechanical strength.

Materials configuring these SOFCs must have durability for a high-temperature cycle, chemical stability, electrochemical activity, long-term stability and reliability.

### SUMMARY OF THE INVENTION

An aspect of the present invention provides a fuel cell including an interconnecting member having durability for a high-temperature cycle, chemical stability and excellent electrical conductivity and a manufacturing method thereof.

According to an aspect of the present invention, there is provided a manufacturing method of a fuel cell, including: providing a support for a fuel cell; and forming an interconnecting member layer including metal-glass and interconnecting unit cells on the support.

The metal may be at least one selected from a group consisting of Ag, Ni, Co, Cu and Fe.

The glass may be BaO—SiO based glass.

The BaO—SiO based glass may have 25 wt % to 30 wt % of BaO and 15 wt % to 25 wt % of SiO.

The metal-glass may have 25 wt % to 75 wt % of metal and 75 wt % to 25 wt % of glass.

The interconnecting member layer may be formed as any one of a slurry, a sheet, a powder, a mesh and a foam.

The interconnecting member layer may be composed of a plurality of layers.

The interconnecting member layer may be coated by a wet coating method, and the wet coating method may use any one of screen printing and dip coating.

The fuel cell may be a solid oxide fuel cell (SOFC).

According to another aspect of the present invention, there is a provided a fuel cell, including: a plurality of unit cells; and an interconnecting member including metal-glass and interconnecting the plurality of unit cells, wherein each of the plurality of unit cells includes: an electrolyte layer; an anode formed on one side of the electrolyte layer to be supplied with fuel; and a cathode formed on the other side of the electrolyte layer to be supplied, with oxidizing gas.

The metal may be at least one selected from a group consisting of Ag, Ni, Co, Cu and Fe.

The glass may be BaO—SiO based glass,

The Bao-SiO based glass may have 25 wt % to 30 wt % of BaO and 15 wt % to 25 wt % of SiO.

The metal-glass may have 25 wt % to 75 wt % of metal and 75 wt % to 25 wt % of glass.

The interconnecting member may be formed as any one of a slurry, a sheet, a powder, a mesh and a foam.

The interconnecting member may interconnect the plularity of unit cells to form a bundle or stack structure of the fuel cell.

The interconnecting member may be composed of a plurality of layers.

The fuel cell may be a cylindrical fuel cell, a flat tubular fuel cell or a flat fuel cell.

The fuel cell may be a solid oxide fuel cell (SOFC).

### BRIEF DESCRIPTION OF THE DRAWINGS

The above and other aspects, features and other advantages of the present invention will be more clearly understood from, the following detailed description taken in conjunction with the accompanying drawings, in which:

FIG. 1 is a schematic cross-sectional diagram showing a unit cell of a fuel cell according to an exemplary embodiment of the present invention;

FIGS. 2A and 2B are schematic diagrams showing a process for forming an interconnecting member for interconnecting unit cells in a fuel cell according to an exemplary embodiment of the present invention;

FIG. 3 is an SEM photograph showing a cross-section of an interconnecting member formed on a support according to an exemplary embodiment of the present invention;

FIG. 4 is an SEM photograph showing the cross section of the interconnecting member formed in FIG. 3; and

FIGS. 5A and 5B are cross-sectional diagrams showing a flat fuel cell and a fiat tubular fuel cell in which, interconnecting members are formed to configure a bundle according to an exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

In addition, unless explicitly described to the contrary, the word “comprise” and variations such as “comprises” or “comprising,” will be understood to imply the inclusion of stated elements but not the exclusion of any other elements.

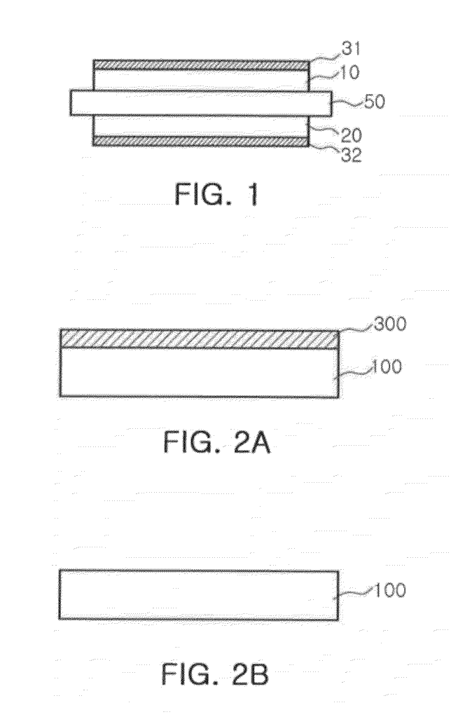

FIG. 1 is a schematic cross-sectional diagram showing a unit cell of a fuel cell according to an exemplary embodiment of the present invention.

The unit cell of the fuel cell according to the exemplary embodiment of the present invention includes an electrolyte layer 50, and a first electrode 10 and a second electrode 20 corresponding to a cathode or an anode and formed on both surfaces of the electrolyte layer.

The unit cell formed with the first electrode 10 and the second electrode 20 is serially or parallelly interconnected to other unit cells to form a bundle or stack structure. The unit cells may be serially or parallelly interconnected to increase a total output voltage or current of the fuel cell.

According to the exemplary embodiment of the present invention, the unit cell is bonded to other unit cells by interconnecting members 31 and 32 formed on the first electrode 10 or the second electrode 20.

Referring to FIG. 1, the interconnecting member 31 formed on the first electrode 10 may be serially interconnected to a second electrode formed in other unit cell and having an opposite polarity to the first electrode 10, and be parallelly interconnected to a first electrode formed in other unit cell and having the same polarity as the first electrode 10.

These interconnecting members 31 and 32 are formed on the first electrode 10 or the second electrode 20, such that various interconnections may be performed.

In an SOFC, the interconnecting member interconnects the unit cells in a bundle or stack structure to be used for manufacturing a large-capacity SOFC. The interconnecting member electrically interconnects each of the unit cells formed of electrolytes and electrodes, separates supplied fuel and air, and simultaneously serves as a mechanical support.

In the case of a cylindrical SOFC, the interconnecting member is referred to as an interconnect, electrically interconnects the unit cells, and simultaneously serves as a passage through which electrical output obtained from each of the unit cells moves.

In the case of a flat SOFC, the interconnecting member is referred, to as a separator, electrically interconnects each of the unit, cells, and separates fuel gas and oxidizing gas supplied to the fuel cell so that these gases do not collided with each other.

In order to manufacture the large-capacity SOFC, a need exists for an interconnecting member capable of efficiently interconnecting fuel cells for implementing high durability and nigh performance.

According to the exemplary embodiment of the present invention, the interconnecting members 31 and 32 may include metal-glass.

The metal may be at least one of Ag, Ni, Co, Cu, and Fe, without being limited thereto, and provide an electrical conductivity to the interconnecting member.

The glass may be BaO—SiO based glass, without being limited thereto. The BaO—SiO based glass may have 25 wt % to 30 wt % of BaO, more specifically, 26.91 wt % and 28.91 wt % of BaO and 15 wt % to 25 wt % of SiO, more specifically, 20.61 wt % to 22.61 wt % of SiO.

The glass is mixed with a metal powder to make the interconnecting member densifled and firm, thereby having high durability and chemical resistance, while improving the adhesion strength between the unit cell and another unit cell.

The interconnecting member may be manufactured as any one of a slurry, a sheet, a powder, a mesh and a foam, between the unit cells, and may be manufactured in various forms to interconnect the unit cells of the fuel cells, thereby forming the bundle or stack structure.

The interconnecting member may be composed of one layer, and have a thick thickness to reduce an electrical resistance of a connecting electrode, thereby reducing a total output resistance of the fuel cell.

Accordingly, the fuel cell may have improved electrical characteristics and high-output and low-resistance characteristics.

The fuel cell according to the exemplary embodiment of the present invention may be formed by a wet coating method and be completed through a heat treatment process. The interconnecting member according to the exemplary embodiment of the present invention may be used in a Solid Oxide Fuel Cell (SOFC). In particular, the inter connecting member has a simple and easy manufacturing process and a high degree of freedom in design, thereby being also used in cylindrical, flan tubular or flat fuel cell. The interconnecting member may be used in the cylindrical, fiat tubular or flat fuel cell to interconnect the unit cells, thereby being used in forming the bundle and stack structure.

That is, a high-capacity SOFC having various structures, such as cylindrical structure, flat tubular structure, fiat structure, may be implemented by applying the interconnecting member according to the exemplary embodiment of the present invention and current collecting resistance may be minimized in the bundle and the stack interconnecting the unit cells.

FIGS. 2A and 2B are schematic diagrams showing a process for forming an interconnecting member interconnecting the unit cells in a fuel cell according to an exemplary embodiment of the present invention.

Referring to FIG. 2A, a support 100 for various fuel cells according to the exemplary embodiment of the present invention is provided. The interconnecting member according to the exemplary embodiment of the present invention may be formed on a support such as an anode support, a cathode support and/or a ceramic support and the Like of the unit cell of the SOFC.

Referring to FIG. 2B, an interconnecting member layer 300 formed on the support 100 and interconnecting the unit cells is formed, the interconnecting member layer 300 including metal-glass.

According to the exemplary embodiment of the present invention, the interconnecting member layer 300 is formed on the support 100 using the metal-glass. The metal-glass may include at least one of AG-glass, Ni-glass, Co-glass, Cu-glass and Fe-glass as, without being limited thereto.

According to the exemplary embodiment of the present invention, the metal-glass may have 25 wt % to 75 wt % of metal and 75 wt % to 25 wt % of glass.

A BaO—SiO based, alloy material is used in the glass of the metal-glass. The BaO—SiO based glass may have 25 wt % to 30 wt % of BaO, more specifically, 26.91 wt % and 28.91 wt % of BaO and 15 wt % to 25 wt % of SrO, more specifically, 20.61 wt % to 22.61 wt % of SiG without being limited thereto.

Also, the SaO—SiO based glass is crystallized at a temperature of 850° C., and is mixed with conductive metal or ceramic to serve as a filler. The BaO—SiO based glass may improve sintering characteristics, while maintaining characteristics of the ceramic mixed therewith or the glass, thereby making it possible to form a dense membrane.

According to the exemplary embodiment, the metal-glass powder is grinded, to be slurry. Then, the slurry is coated on the anode support, the cathode support or the ceramic support by the wet coating method, such that the interconnecting member layer is manufactured on the anode support, the cathode support or the ceramic support. The wet coating method may any one of screen printing and dip coating, without being limited thereto. After coating, the interconnecting member may be subjected to heat treatment at a temperature of about 850° C. to be densified, without being limited thereto.

In addition, the inter connecting member layer according to the exemplary embodiment of the present invention may be formed as any one of a slurry, a sheet, a powder, a mesh and a foam. As an example, the interconnecting member layer may be used on the support in a sheet membrane form by a tape casting method.

The interconnecting member layer may be composed of a multi-layer of a single-layer or more, such that a thickness thereof may be adjusted.

Since the interconnecting member layer 300 manufactured according to the exemplary embodiment of the present invention includes the glass, it is not peeled even after it is adhered to the support 100 and is subjected to the heat treatment. Also, unlike an existing LaCrO₃ based ceramic, a phenomenon in which the expansion of volume occurs in a reduction atmosphere may be prevented, such that electrical resistance does not increase.

In addition, a high-density membrane and a high-conductivity membrane may be easily manufactured by increasing the coating thickness of the interconnecting member layer or making the interconnecting member layer multilayered. Also, the interconnecting member layer is formed to improve electrical characteristics of the bundle or the stack of the unit cells, such that a fuel cell having improved capacity characteristics may be manufactured.

That is, the unit cells are interconnected using a metal-glass material according to the present invention to minimize the current collecting resistance, such that the bundle and the stack having high performance and high durability may be manufactured. In addition, in manufacturing the fuel cell, a process for forming the interconnecting member between the unit cells may be simplified, and since the interconnecting member has the glass, a heat treatment temperature may be lowered to shorten a process time.

When the interconnecting member according to the exemplary embodiment of the present invention is used on all of the supports such as an anode support, a cathode support, a ceramic support and the like, a current collecting connection process may be simplified, and the SOFC having a large-capacity stack structure may be manufactured in a simple manner.

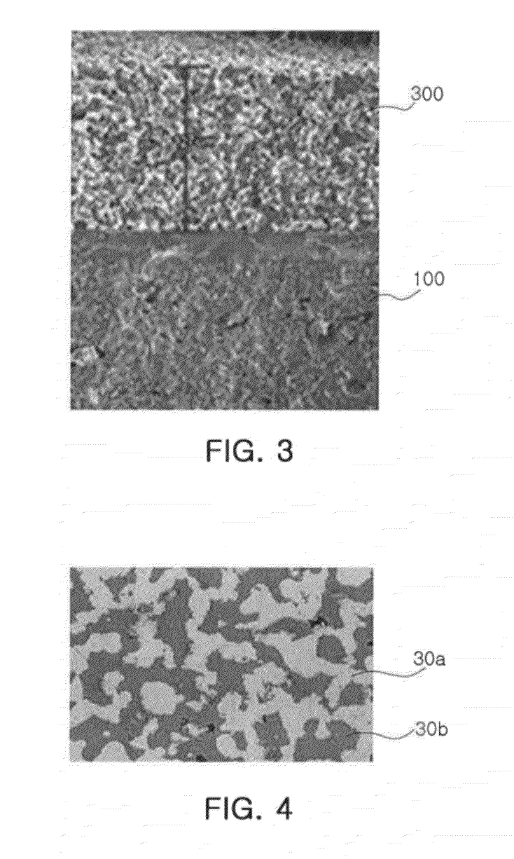

FIG. 3 is an SEM photograph showing a cross-section of the interconnecting member formed on the support 100 according to the exemplary embodiment of the present invention. FIG. 4 is an SEM photograph showing the cross section of the interconnecting member formed in FIG. 3.

It may be appreciated that in the interconnecting member layer 300, Ag particles, which are conductive metal particles 30a, are connected and a space except for the Ag particles is filled with glass 30b.

Referring to FIGS. 3 and 4, once the metal-glass interconnecting member 300 is manufactured in a membrane form, the space except for the conductive metal particles 30a is filled with the glass 30b.

The glass may have a structure in which conductive metal particles such as AG, Ni and the like, without limited thereto, may be uniformly mixed with the glass such that the space except for the conductive metal particles is filled with the glass may be formed.

That is, the conductive metal particles are uniformly connected to each other, thereby making it possible to maintain excellent electrical conductivity and sintering characteristics is improved by the added glass, thereby making it possible to form a densified membrane. Therefore, the interconnecting characteristics of the unit cells, the bundle and the stack may be improved, thereby making it possible to improve a total output of the fuel cell and accomplish a mechanically firm interconnecting structure.

As a result of the structure, high electrical conductivity may be obtained. Therefore, a plurality of unit cells are efficiently interconnected in the SOFC, such that the performance of the unit cell, the bundle and stack structure may be considerably improved.

Also, since the glass according to the exemplary embodiment of the present invention may be easily coated over a surface of the support (an anode, a cathode, a ceramic, and the like) of the SOFC, it may be modified and used in various forms. That is, designs may be performed in various forms.

Therefore, according to the exemplary embodiment of the present invention, the interconnecting member is provided in the SOFC, the interconnecting member being capable of being easily coated on any types of surfaces and improving adhesion on a bonded interface after the heat treatment to minimize the resistance of the interface. That is, this interconnecting member is used in the SOFC, such that the SOFC has high performance and high durability.

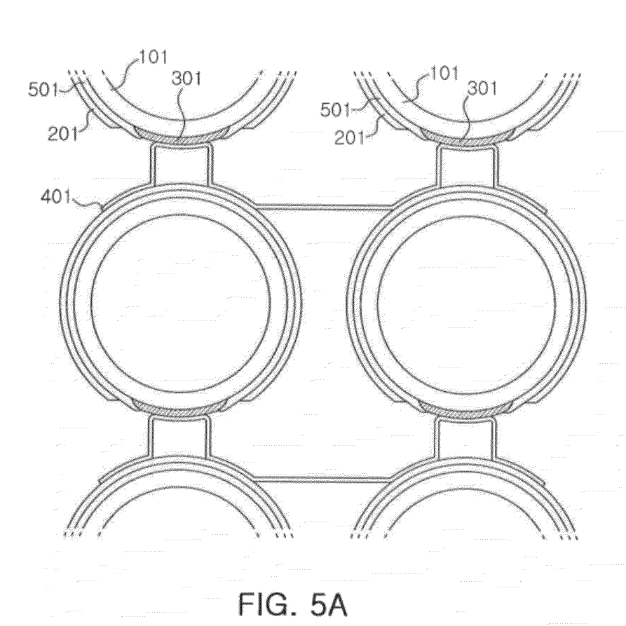

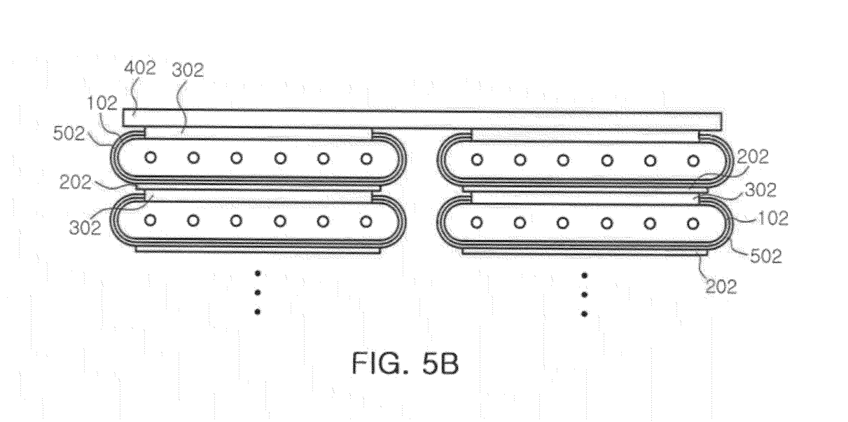

FIGS. 5A and 5B are cross-sectional diagrams showing a flat fuel cell and a flat tubular fuel cell in which interconnecting members are formed to configure a bundle according to en exemplary embodiment of the present invention.

FIG. 5A shows a schematic diagram of a cylindrical fuel cell having a bundle structure formed according to an exemplary embodiment of the present invention.

According to the exemplary embodiment of the present invention, each of unit cells of the cylindrical fuel cell includes a first electrode 101 corresponding to a cathode, a second electrode 201 corresponding to an anode, and a solid, oxide electrolyte layer 501 formed therebetween. The first electrode 101, the second electrode 201, and the electrolyte layer 501 have a cylindrical structure.

In the cylindrical unit cell, a metal glass interconnecting member layer 301 is formed on the first, electrode 101, and the metal glass interconnecting member layer 301 is electrically connected to the second electrode and the first electrode of other fuel cell by a conductive member 401.

Referring to FIG. 5A, each of the unit cells is interconnected in serial and parallel, structures by the metal glass interconnecting member layer 301 and the conductive member 401 to form, a single bundle. This structure has a self-sealing function to improve a thermal stability.

FIG. 5B shows a schematic diagram of a fiat tubular fuel cell having a stack structure formed according to an exemplary embodiment.

According to the exemplary embodiment of the present invention, each of unit cells of the flat tubular fuel cell includes a first electrode 102 corresponding to an anode, a second electrode 202 corresponding to a cathode, and a solid oxide electrolyte layer 502 formed therebetween. The first electrode 102, the second electrode 202, and the electrolyte layer 502 have a flat tubular structure.

According to the exemplary embodiment of the present invention, the interconnecting member 302 is formed on the support. The support may be a ceramic support without being limited thereto.

According to the exemplary embodiment of the present invention, the unit cells are stacked using the metal, glass interconnecting member layer 302 to form a stack structure.

The first electrode 101 of one unit cell and the second electrode 202 of another unit cell are electrically interconnected, in series by the interconnecting member layer 302. The fuel, cell having the stack structure stacked, in this manner may be interconnected, in parallel, to the fuel cell having another stack structure by a conductive member 402 to configure a large-capacity fuel cell.

### Embodiment 1

In order to confirm electrical characteristics of the metal-glass interconnecting member manufactured according to embodiment 1 of the present invention, electrical conductivities were compared.

After manufacturing a synthesized slurry of Ag-glass according to embodiment 1 of the present invention, the interconnecting member layer was printed on the ceramic substrate by a screen printing method. Heat treatment was subsequently performed at a temperature of 850° C.

The change of the electrical conductivity was tested while changing content of AG and glass on the basis of the electrical conductivity when the content of AG is 100%.

TABLE 1

| | Content | Content | Electrical |
|---|---|---|---|
| Composition | of Ag | of glass | Conductivity |
| Ratio | (wt %) | (wt %) | (%) |
| 1 | 25 | 75 | 0 |
| 2 | 50 | 50 | 0 |
| 3 | 60 | 40 | 0 |
| 4 | 75 | 25 | 90 |
| 5 | 90 | 10 | 95 |
| 6 | 100 | 0 | 100 |

Referring to Table 1, it can be appreciated that the electrical conductivity in the case in which the weight ratio of Ag powder was 75 wt % and the weight ratio of glass powder was 25 wt % was 90%, which is very similar to the electrical conductivity in the case in which the weight ratio of the Ag powder is 100 wt %.

As a result, it can be appreciated that since a SOFC tray he manufactured to have the interconnecting member including metal-glass, it may have excellent electrical conductivity after heat treatment due to the metal and have excellent density due to the glass.

According to the exemplary embodiment of the present invention, since the metal-glass interconnecting member which is stable even in oxidization and reduction atmospheres is used, high performance and high durability may be implemented in the unit cell, the bundle and the stack of the SOFC, thereby making it possible to manufacture a large-capacity SOFC.

In addition, since the metal-glass interconnecting member has the conductive metal, it may have a stable structure in the oxidization and reduction atmospheres, while having excellent electrical conductivity.

The metal-glass interconnecting member has a lower heat treatment temperature than a LaCrO₃ based ceramic interconnecting member used in the unit cell, the bundle and the stack of an existing SOFC to prevent thermal and chemical reactions with other material, thereby making it possible to form a stable structure. And, the glass is added, thereby making it possible to improve interface adhesion with other configuration material as well as easily manufacture a membrane having high density through a simple process.

The unit cell, the bundle and the stack of the fuel cell can be manufactured through the simple manufacturing process, the SOFC can have a large-capacity, and the interconnecting member layer can be formed on various supports, thereby making it possible to improve the degree of freedom in design of the SOFC. That is, since the interconnecting member layer having various thicknesses may be formed, resistance loss according to the thickness is minimized, thereby making it possible to manufacture the SOFC having high performance and high durability.

In addition, the manufacturing process is simplified, thereby making it possible to lower the manufacture costs of the SOFC and mass-produce the SOFC.

As set forth above, according to exemplary embodiments of the invention, a fuel cell including an interconnecting member having durability for a high-temperature cycle, chemical stability and excellent electrical conductivity and a manufacturing method thereof are provided.

While the present invention has been shown and described in connection with the exemplary embodiments, it will be apparent to those skilled in the art that modification and variation can be made withough departing from the spirit and scope of the invention as defined by the appended claims.

What is claimed is:

1. A manufacturing method of a fuel cell, comprising:
providing a support for the fuel cell; and
forming an interconnecting member layer including metal-glass and interconnecting unit cells on the support.

2. The manufacturing method of a fuel cell of claim 1, wherein the metal is at least one selected from a group consisting of Ag, Ni, Co, Cu and Fe.

3. The manufacturing method of a fuel cell of claim 1, wherein the glass is BaO—SiO based glass.

4. The manufacturing method of a fuel cell of claim 3, wherein the Bao-SiO based glass has 25 wt % to 30 wt % of BaO and 15 wt % to 25 wt % of SiO.

5. The manufacturing method of a fuel cell of claim 1, wherein the metal-glass has 25 wt % to 75 wt % of metal and 75 wt % to 25 wt % of glass.

6. The manufacturing method of a fuel cell of claim 1, wherein the interconnecting member layer is formed as any one of a slurry, a sheet, a powder, a mesh and a foam.

7. The manufacturing method of a fuel cell of claim 1, wherein the interconnecting member layer is composed of a plurality of layers.

8. The manufacturing method of a fuel cell of claim 1, wherein the interconnecting member layer is coated by a wet coating method.

9. The manufacturing method of a fuel cell of claim 8, wherein the wet coating method is any one of screent printing and dip coating.

10. The manufacturing method, of a fuel cell of claim 1, wherein the fuel cell is a solid oxide fuel cell (SOFC).

11. A fuel cell, comprising:
a plurality of unit cells; and
an interconnecting member including metal-glass and interconnecting the plurality of unit cells,
wherein each of the plurality of unit cells includes;
an electrolyte layer;
an anode formed on one side of the electrolyte layer to be supplied with fuel; and
a cathode formed on the other side of the electrolyte layer to be supplied with oxidizing gas.

12. The fuel cell of claim 11, wherein the metal is at least one selected from a group consisting of Ag, Ni, Co, Cu and Fe.

13. The fuel cell of claim 11, wherein the glass is BaO—SiO based glass.

14. The fuel cell of claim 13, wherein the BaO—SiO based glass has 25 wt % to 30 wt % of BaO and 15 wt % to 25 wt % of SiO.

15. The fuel cell of claim 11, wherein the metal-glass has 25 wt % to 75 wt % of metal and 75 wt % to 25 wt % of glass.

16. The fuel cell of claim 11, wherein the interconnecting member is formed as any one of a slurry, a sheet, a powder, a mesh and a foam.

17. The fuel cell of claim 11, wherein the interconnecting member interconnects the piuiarity of unit cells to form a bundle or stack structure of the fuel cell.

18. The fuel cell of claim 11, wherein the interconnecting member is composed of a plurality of layers.

19. The fuel cell of claim 11, wherein the fuel cell is a cylindrical fuel cell, a flat tubular fuel cell or a flat fuel cell.

20. The fuel cell of claim 11, wherein the fuel cell is a solid oxide fuel cell (SOFC).
